(19) United States
(12) Patent Application Publication
(10) Pub. No.: US 2026/0126611 A1
(43) Pub. Date: May 7, 2026

(54) OPTICAL ELEMENT DRIVING MECHANISM

(71) Applicant: TDK TAIWAN CORP., Taoyuan City (TW)

(72) Inventor: Yi-Ho CHEN, Taoyuan CIty (TW)

(21) Appl. No.: 18/937,605

(22) Filed: Nov. 5, 2024

(51) Int. Cl. G02B 7/09; G02B 27/64; G03B 13/36; H04N 23/54; H04N 23/68

(52) U.S. Cl. CPC G02B 7/09; G02B 27/646; G03B 13/36; H04N 23/54; H04N 23/687

(57) ABSTRACT

An optical element driving mechanism is provided, which includes a first movable portion, a fixed portion, and a driving assembly. The first movable portion is used for connecting an optical element. The first movable portion is movable relative to the fixed portion. The driving assembly is used for driving the first movable portion to move relative to the fixed portion. The driving assembly can drive the first movable portion to move from a first state to a second state relative to the fixed portion, and the first state and the second state are included in a movable range.

### BACKGROUND OF THE INVENTION

### Field of the Invention

The present disclosure relates to an optical element driving mechanism.

### Description of the Related Art

As technology has developed, it has become more common to include image-capturing and video-recording functions into many types of modern electronic devices, such as smartphones and digital cameras. These electronic devices are used more and more often, and new models have been developed that are convenient, thin, and lightweight, offering more choice to consumers.

Electronic devices that have image-capturing or video-recording functions normally include an optical system to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY OF THE INVENTION

An optical element driving mechanism is provided, which includes a first movable portion, a fixed portion, and a driving assembly. The first movable portion is used for connecting an optical element. The first movable portion is movable relative to the fixed portion. The driving assembly is used for driving the first movable portion to move relative to the fixed portion. The driving assembly can drive the first movable portion to move from a first state to a second state relative to the fixed portion, and the first state and the second state are included in a movable range.

In some embodiments, the optical element driving mechanism further includes a support assembly, wherein the first movable portion is movable relative to the fixed portion through the support assembly, and the support assembly includes a first intermediate element, a first support element corresponding to the first intermediate element and having a first recessed structure, and a second support element corresponding to the first intermediate element and having a second recessed structure. The first recessed structure is formed on a first surface. The second recessed structure is formed on the first surface. The first intermediate element is at least partially disposed in the first recessed structure and the second recessed structure. The first recessed structure is different from the second recessed structure. The first movable portion is rotatable relative to the fixed portion around a first rotational axis, and the first rotational axis does not overlap a center of the optical element when viewed along the first rotational axis.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of an optical element driving mechanism.

FIG. 1B is an exploded view of the optical element driving mechanism.

FIG. 1C is a top view of the optical element driving mechanism.

FIG. 2A is a cross-sectional view illustrated along a line A-A in FIG. 1C.

FIG. 2B is a cross-sectional view illustrated along a line B-B in FIG. 1C.

FIG. 2C is a cross-sectional view illustrated along a line C-C in FIG. 1C.

FIG. 3A is a top view of some elements of the optical element driving mechanism.

FIG. 3B is a top view of some elements of the optical element driving mechanism.

FIG. 4A is a cross-sectional view illustrated along a line D-D in FIG. 3B.

FIG. 4B is an enlarged view of a region area in FIG. 4A in some embodiments.

FIG. 4C is an enlarged view of the area of FIG. 4A in other embodiments.

FIG. 4D is a schematic view of the bottom and the first intermediate element.

FIG. 5A and FIG. 5B are schematic views showing the positional relationships of some elements when the first movable portion is in the first state and the second state relative to the fixed portion, respectively, when a first recessed structure having a cylindrical shape is used.

FIG. 5C is a schematic view showing the positional relationships of some elements when the first movable portion is in the first state and the second state relative to the fixed portion, respectively, when a first recessed structure having a triangular shape is used.

FIG. 6A, FIG. 6B, and FIG. 6C are top views of some elements of the optical element driving mechanism

FIG. 7A, FIG. 7B, FIG. 7C, and FIG. 7D are schematic views showing sensor signal values output when the first movable portion moves relative to the fixed portion.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

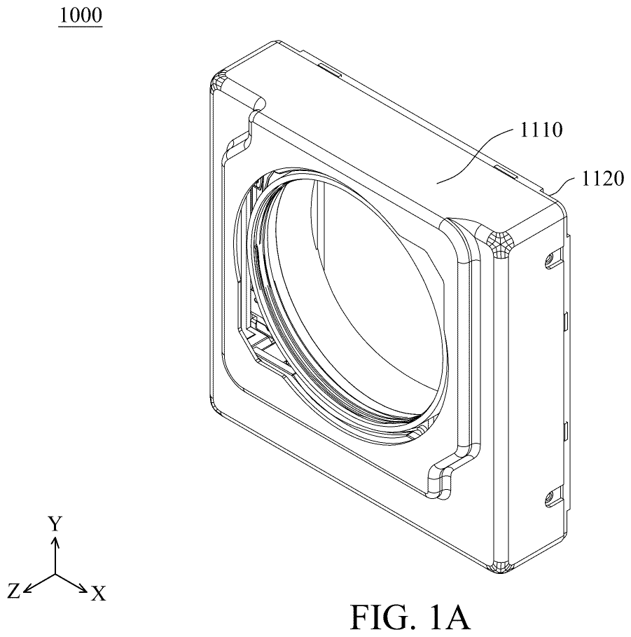

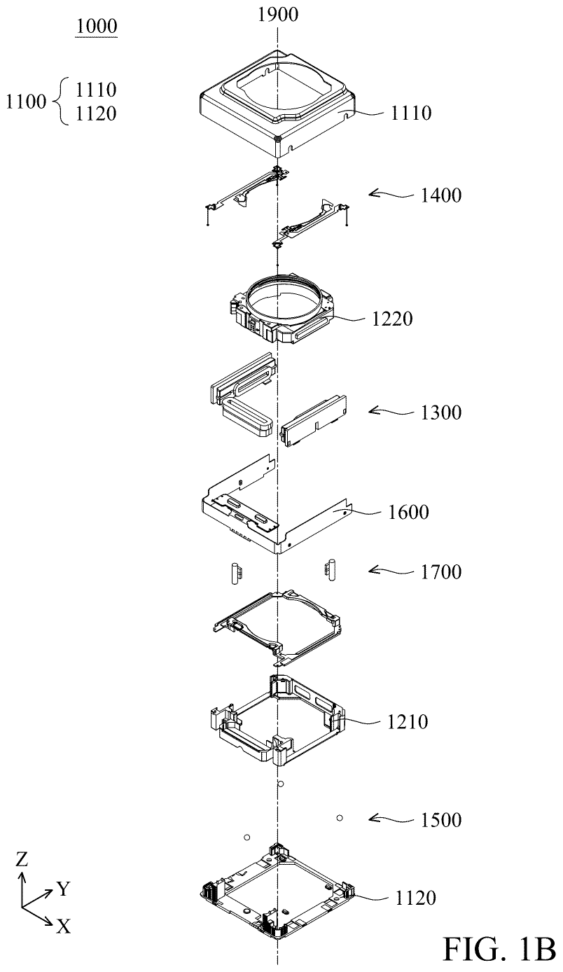

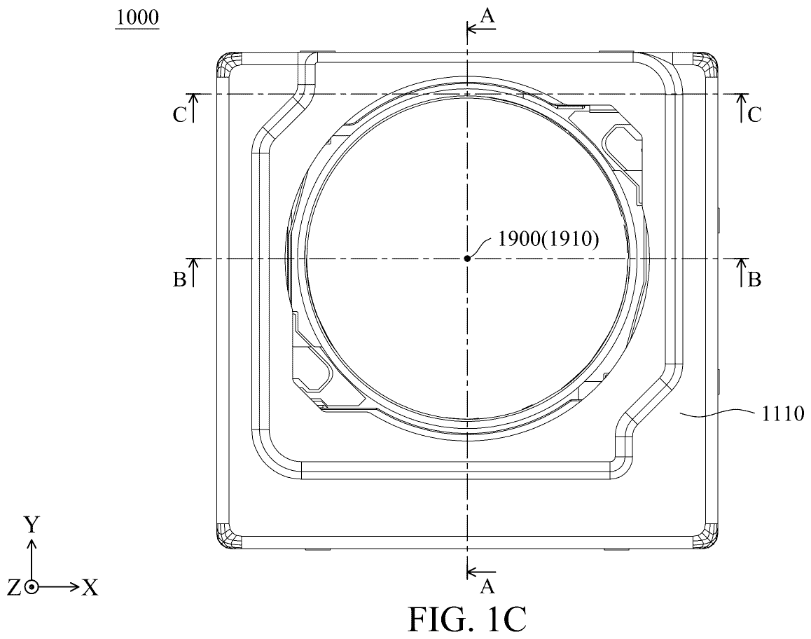

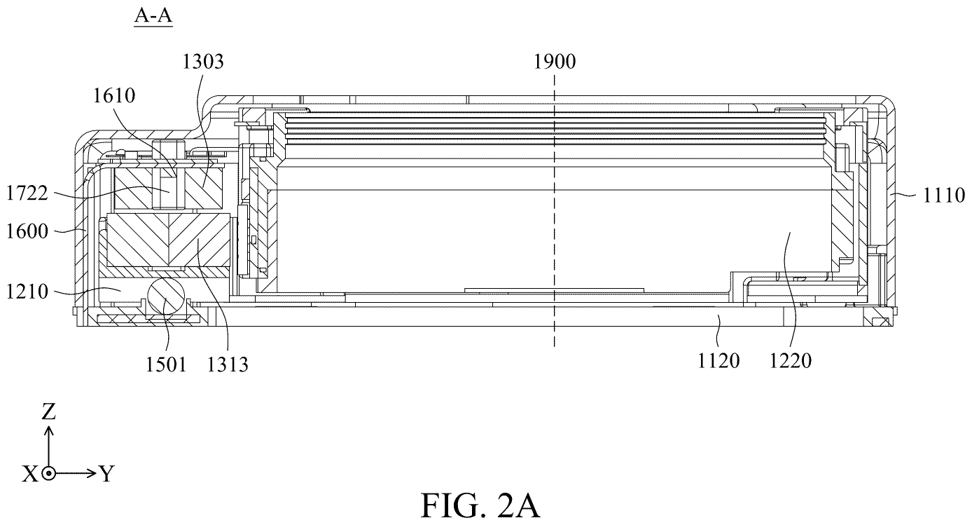

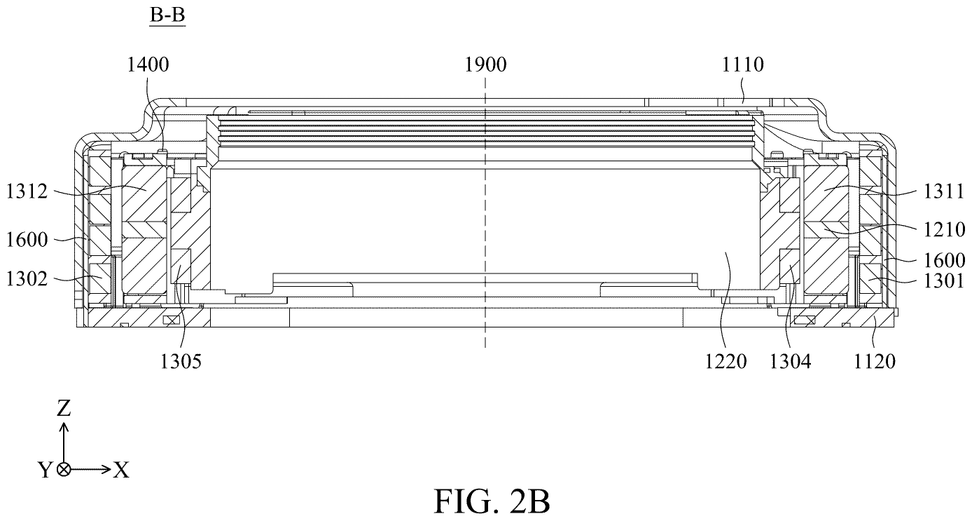

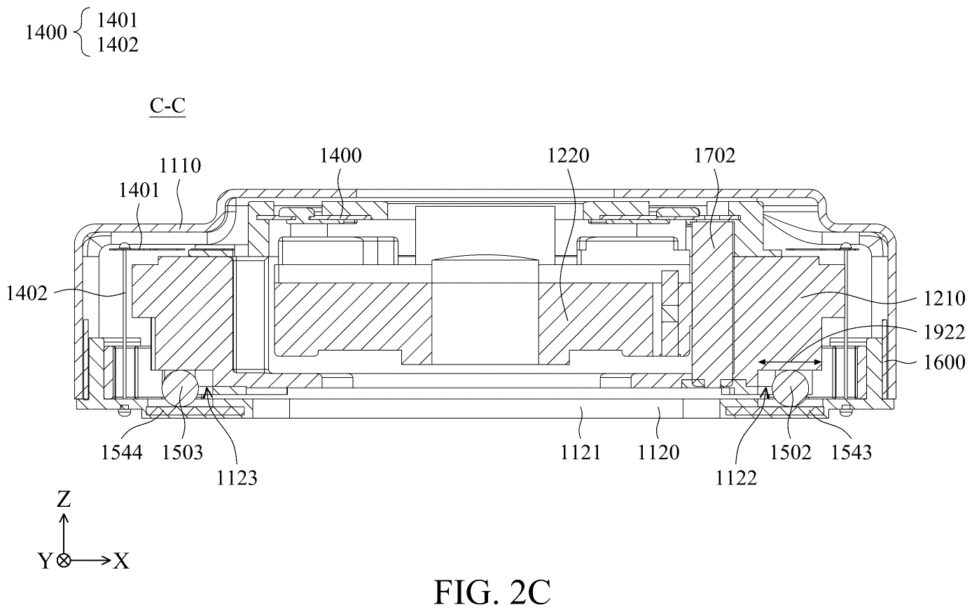

An optical element driving mechanism used for driving an optical element to move is provided in some embodiments of the present disclosure. For example, FIG. 1A is a schematic view of an optical element driving mechanism 1000. FIG. 1B is an exploded view of the optical element driving mechanism 1000. FIG. 1C is a top view of the optical element driving mechanism 1000. FIG. 2A is a cross-sectional view illustrated along a line A-A in FIG. 1C. FIG. 2B is a cross-sectional view illustrated along a line B-B in FIG. 1C. FIG. 2C is a cross-sectional view illustrated along a line C-C in FIG. 1C.

As shown in FIG. 1A to FIG. 2C, the optical element driving mechanism 1000 may mainly include a fixed portion 1100 (which includes a case 1110 and a bottom 1120), a first movable portion 1210, a second movable portion 1220, a driving assembly 1300, a conductive assembly 1400, a support assembly 1500, a circuit element 1600, and an intermediate assembly 1700 arranged along an optical axis 1900, and the optical element driving mechanism 1000 is used for driving an optical element (not shown) to move. The optical axis 1900 may pass through the center of the optical element (such as geometric center) and may extend along the Z axis.

In some embodiments, the optical element may be disposed on the second movable portion 1220, such as may be fixed in the second movable portion 1220 by means of locking, bonding, or snapping. The optical element may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the case 1110 and the bottom 1120 of the fixed portion 1100 may be combined to form a shell of the optical element driving mechanism 1000, and other elements of the optical element driving mechanism 1000 may be disposed in the shell formed by the case 1110 and the bottom 1120 to protect these elements. For example, the bottom 1120 may be affixed on the case 1110. In some embodiments, additional circuit may be embedded in the bottom 1120 to allow the elements in the optical element driving mechanism 1000 being electrically connected to other elements.

In some embodiments, the first movable portion 1210 and the second movable portion 1220 may be disposed in the fixed portion 1100 and may move relative to the fixed portion 1100. In other words, the first movable portion 1210 and the second movable portion 1220 may be movably connected to the fixed portion 1100. Moreover, the second movable portion 1220 may be disposed in the first movable portion 1210, and the first movable portion 1210 is movable relative to the second movable portion 1220.

In some embodiments, the driving assembly 1300 may be used for driving the first movable portion 1210 and the second movable portion 1220 to move relative to the fixed portion 1100 to achieve auto focus (AF) or optical image stabilization (OIS). In some embodiments, the first movable portion 1210 may move in the X axis and the Y axis, and the second movable portion 1220 may move in the Z axis. The driving assembly 1300 may drive the first movable portion 1210 to transfer from a first state to a second state relative to the fixed portion 1100, such as move from an initial position to a specific position. The first state and the second state are within the movable range of the first movable portion 1210, such as translate to different positions or rotate to various angles.

In some embodiments, the material of the conductive assembly 1400 may include metal, and the conductive assembly 1400 may be disposed between the first movable portion 1210, the second movable portion 1220, and the fixed portion 1100 to movably connect the first movable portion 1210 and the second movable portion 1220 to the fixed portion 1100. Therefore, the first movable portion 1210, the second movable portion 1220, and the optical element disposed on the second movable portion 1220 may move relative to the fixed portion 1100. Furthermore, the conductive assembly 1400 may be electrically connected to the circuit embedded in the bottom 1120 to electrically connect to other electrical elements in the optical element driving mechanism 1000. In some embodiments, the conductive assembly 1400 may be electrically connected to an external module (not shown, such as aperture, shutter or other optical modules), and the external module may be disposed on the second movable portion 1220 to move with the second movable portion 1220 and the optical element.

Specifically, in some embodiments, as shown in FIG. 2C, the conductive assembly 1400 may include a first conductive portion 1401 and a second conductive portion 1402. The first conductive portion 1401 may be plate-shaped may extend in the XY plane. The second conductive portion 1402 may be strip-shaped and may extend along the Z axis. The first conductive portion 1401 may be used for electrically connecting to the external module (not shown) disposed on the second movable portion 1220. Afterwards, the second conductive portion 1402 may be electrically connected to the first conductive portion 1401. Additional circuit may be provided in the bottom 1120, and the circuit may be electrically connected to the first conductive portion 1401. The first conductive portion 1401 may be combined to the second conductive portion 1402 by soldering or laser welding, and the second conductive portion 1402 and the circuit in the bottom 1120 may also be combined by soldering or laser welding. In other words, the external module disposed on the second movable portion 1220 may be electrically connected to the circuit in the bottom 1120 through the conductive assembly 1400, so electrical signal for controlling may be provided to the external module.

In some embodiments, the support assembly 1500 may be disposed between the fixed portion 1100 and the first movable portion 1210 to allow the first movable portion 1210 moving relative to the fixed portion 1100 through the support assembly 1500. Moreover, the intermediate assembly 1700 may be disposed between the first movable portion 1210 and the second movable portion 1220 to allow the second movable portion 1220 moving relative to the first movable portion 1210 through the intermediate assembly 1700.

In some embodiments, the circuit element 1600 may be a printed circuit board (PCB), such as may be affixed on the fixed portion 1100 and the first movable portion 1210 by adhesion. The circuit element 1600 is used for electrically connecting to other elements (e.g. the driving assembly 1300) in the optical element driving mechanism 1000 and other external devices to provide electrical signals to these elements. Therefore, the movements of the first movable portion 1210 and the second movable portion 1220 in the X, Y, and Z axes may be controlled to achieve auto focus or optical image stabilization. In some embodiments, the driving assembly 1300 may be affixed on the circuit element 1600 by adhesion.

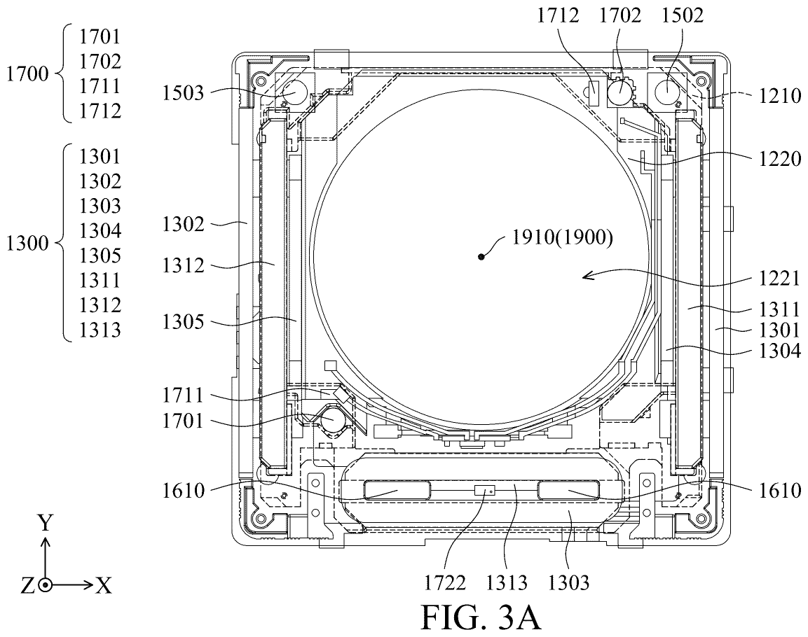

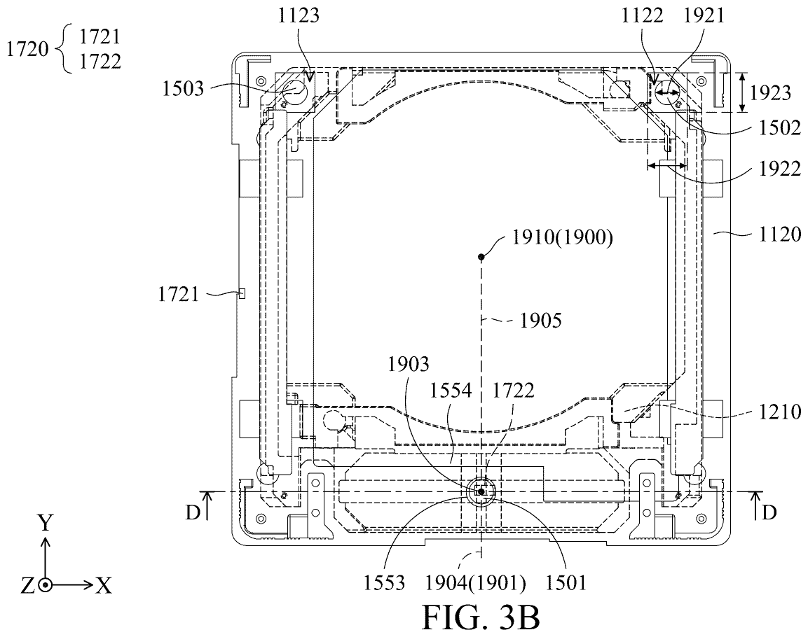

FIG. 3A is a top view of some elements of the optical element driving mechanism 1000. Some elements are omitted to show position relationship of other elements more clearly. As shown in FIG. 2A, FIG. 2B, and FIG. 3A, the driving assembly 1300 may include a first coil 1301, a second coil 1302, a third coil 1303, a fourth coil 1304, a fifth coil 1305, a first magnetic element 1311, a second magnetic element 1312, and a third magnetic element 1313. The first coil 1301, the second coil 1302, and the third coil 1303 may be disposed on the circuit element 1600, and may be disposed on the fixed portion 1100 (such as the bottom 1120) through the circuit element 1600. The first magnetic element 1311, the second magnetic element 1312, and the third magnetic element 1313 may be disposed on the first movable portion 1210, and the fourth coil 1304 and the fifth coil 1305 may be disposed on the second movable portion 1220.

The first magnetic element 1311, the second magnetic element 1312, and the third magnetic element 1313 may be magnets, such as may be multipolar magnets. The first coil 1301, the second coil 1302, the third coil 1303, the fourth coil 1304, and the fifth coil 1305 may include a single coil, or may include a coil assembly including multiple coils embedded in a circuit board to provide magnetic field in different directions.

In some embodiments, the first coil 1301 and the fourth coil 1304 may correspond to the first magnetic element 1311, such as the first magnetic element 1311 may be disposed between the first coil 1301 and the fourth coil 1304, and the first coil 1301, the first magnetic element 1311, and the fourth coil 1304 may sequentially arrange in the X axis. Therefore, when current passes through the first coil 1301 and the fourth coil 1304, the first coil 1301 and the fourth coil 1304 may generate electromagnetic forces in different directions with the first magnetic element 1311 to drive the first movable portion 1210 to move relative to the fixed portion 1100, and drive the second movable portion 1220 to move relative to the first movable portion 1210, respectively. For example, the first coil 1301 and the first magnetic element 1311 may generate a driving force parallel to the X axis to drive the first movable portion 1210 moving relative to the fixed portion 1100 in the X axis. The fourth coil 1304 and the first magnetic element 1311 may generate a driving force parallel to the Z axis to drive the second movable portion 1220 moving relative to the fixed portion 1100 in the Z axis. In some embodiments, the first coil 1301 may be plate-shaped and have a normal vector parallel to the X axis.

Similarly, in some embodiments, the second coil 1302 and the fifth coil 1305 may correspond to the second magnetic element 1312, such as the second magnetic element 1312 may be disposed between the second coil 1302 and the fifth coil 1305, and the second coil 1302, the second magnetic element 1312, and the fifth coil 1305 may sequentially arrange in the X axis. Therefore, when current passes through the second coil 1302 and the fifth coil 1305, the second coil 1302 and the fifth coil 1305 may generate electromagnetic forces in different directions with the second magnetic element 1312 to drive the first movable portion 1210 to move relative to the fixed portion 1100, and drive the second movable portion 1220 to move relative to the first movable portion 1210, respectively. For example, the second coil 1302 and the second magnetic element 1312 may generate a driving force parallel to the X axis to drive the first movable portion 1210 moving relative to the fixed portion 1100 in the X axis. The fifth coil 1305 and the second magnetic element 1312 may generate a driving force parallel to the Z axis to drive the second movable portion 1220 moving relative to the fixed portion 1100 in the Z axis. In some embodiments, the second coil 1302 may be plate-shaped and have a normal vector parallel to the X axis.

In some embodiments, the third coil 1303 may correspond to the third magnetic element 1313, such as may arrange in the Z axis and may be at least partially overlap each other. Therefore, when current is passed through the third coil 1303, an electromagnetic driving force in the Y axis may be generated by the third coil 1303 and the third magnetic element 1313 to drive the first movable portion 1210 moving relative to the fixed portion 1100 in the Y axis.

In some embodiments, as shown in FIG. 2A and FIG. 3A, a plurality of positioning elements 1610 may be provided in the third coil 1303, such as may be affixed on the circuit element 1600 to define the position of the third coil 1303. For example, the third coil 1303 may be wound around two positioning elements 1610. In some embodiments, a second sensing element 1722 may be disposed in the third coil 1303, such as may be disposed between two positioning elements 1610 to protect the second sensing element 1722 and achieve a better sensing result.

The optical element may be driven in the X, Y, and Z axes by the driving assembly 1300 to achieve auto focus and optical image stabilization. Furthermore, the first coil 1301 and the fourth coil 1304 used for driving in different directions use the same first magnetic element 1311, and the second coil 1302 and the fifth coil 1305 also use a same second magnetic element 1312, so the number of required magnetic elements may be decreases to reduce the cost and achieve miniaturization. In some embodiments, the driving assembly 1300 may include other driving elements, such as piezoelectric elements or shape memory alloy elements.

In some embodiments, as shown in FIG. 2C and FIG. 3A, the intermediate assembly 1700 may include a first intermediate unit 1701, a second intermediate unit 1702, a first auxiliary magnetic element 1711, and a second auxiliary magnetic element 1712. The first intermediate unit 1701 and the second intermediate unit 1702 may be affixed on one of the first movable portion 1210 and the second movable portion 1220 and may move relative to the other one, such as may be disposed on the other one by frictional contact. For example, the first intermediate unit 1701 and the second intermediate unit 1702 may be affixed on the first movable portion 1210, and may be disposed on the second movable portion 1220 by frictional contact. In some embodiments, the first intermediate unit 1701 and the second intermediate unit 1702 may also be affixed on the second movable portion 1220, and may be disposed on the first movable portion 1210 by frictional contact, depending on design requirement. In some embodiments, the first intermediate unit 1701 and the second intermediate unit 1702 may extend along the Z axis to control the movement direction of the second movable portion 1220 relative to the first movable portion 1210.

In some embodiments, the first intermediate unit 1701 and the second intermediate unit 1702 may be magnetic permeable. The first auxiliary magnetic element 1711 and the second auxiliary magnetic element 1712 may be disposed on the second movable portion 1220 and may correspond to the first intermediate unit 1701 and the second intermediate unit 1702, respectively. The second movable portion 1220 is partially disposed between the first intermediate unit 1701 and the first auxiliary magnetic element 1711, and partially disposed between the second intermediate unit 1702 and the second auxiliary magnetic element 1712. The first intermediate unit 1701 and the second intermediate unit 1702 may generate magnetic attraction forces with the first auxiliary magnetic element 1711 and the second auxiliary magnetic element 1712, respectively, to apply a force toward the second movable portion 1220 to the first intermediate unit 1701 and the second intermediate unit 1702. Therefore, the first intermediate unit 1701 and the second intermediate unit 1702 may be disposed on the second movable portion 1220 by friction contact to affix the position of the second movable portion 1220 relative to the first movable portion 1210 when no current is provided.

Afterwards, when current is provided to the driving assembly 1300, if the force applied by the driving assembly 1300 to the second movable portion 1220 in the Z axis is greater than the maximum static frictions between the first intermediate unit 1701 and the second movable portion 1220, and between the second intermediate unit 1702 and the second movable portion 1220, the second movable portion 1220 may move relative to the first intermediate unit 1701 and the second intermediate unit 1702, which means the second movable portion 1220 may move relative the first movable portion 1210. Therefore, the optical element disposed on the second movable portion 1220 may keep its focus on certain position to improve the optical quality of the resulting image.

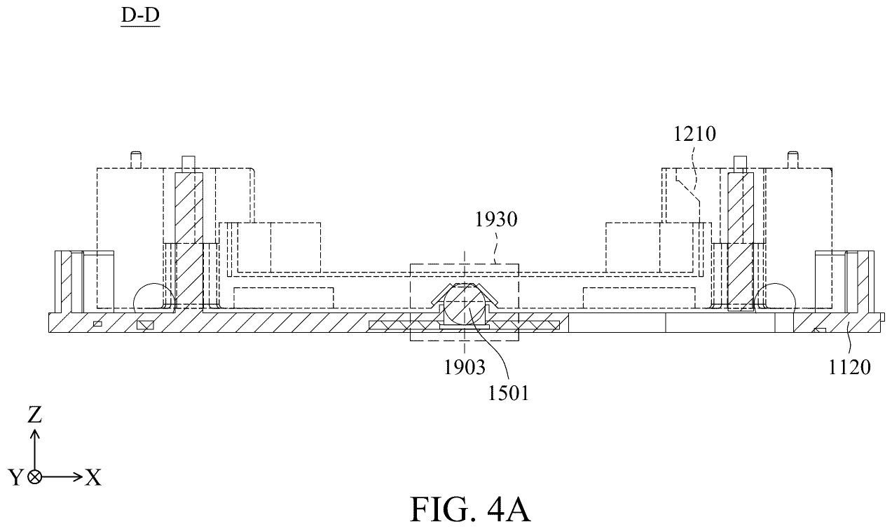

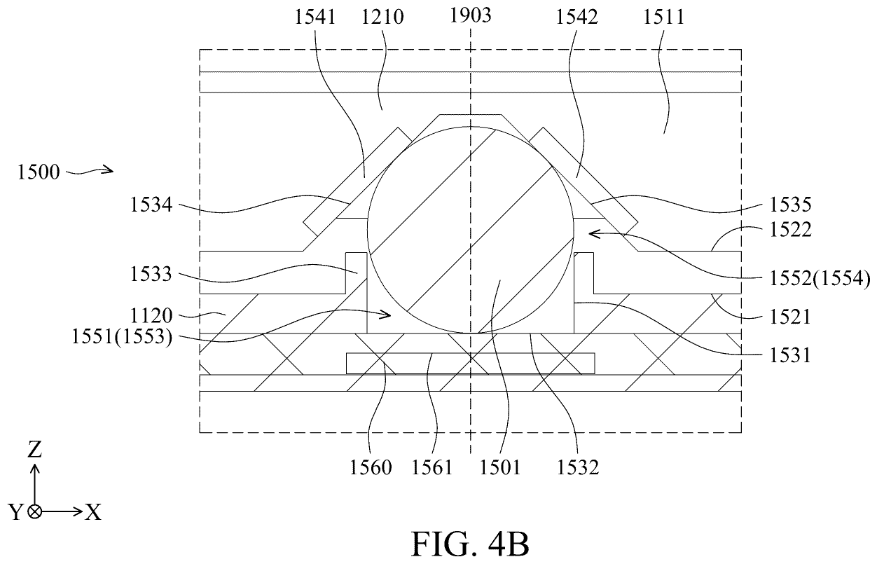

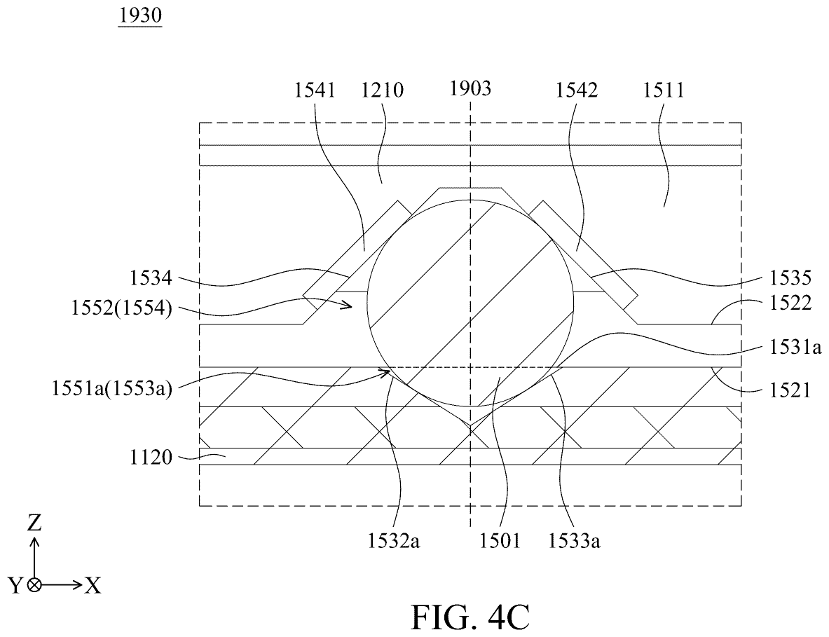

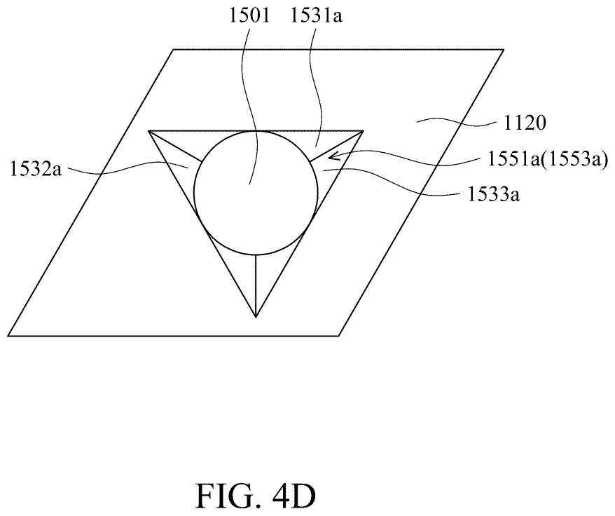

FIG. 3B is a top view of some elements of the optical element driving mechanism 1000. Some elements are omitted to show position relationship of other elements more clearly. FIG. 4A is a cross-sectional view illustrated along a line D-D in FIG. 3B. FIG. 4B is an enlarged view of an area 1930 in FIG. 4A in some embodiments. As shown in FIG. 3B, FIG. 4A, and FIG. 4B, the support assembly 1500 may include a first intermediate element 1501, a first main body 1511, a first strengthen element 1541, a second strengthen element 1542, a first support element 1551, and a second support element 1552. In some embodiments, the first main body 1511 and the first movable portion 1210 may be formed as one piece, such as the first main body 1511 may be a portion of the first movable portion 1210. A second surface 1522 may be formed on the first main body 1511. The first support element 1551 may be formed on the first surface 1521 of the bottom 1120 and may include a first recessed structure 1553. The second support element 1552 may be formed on the second surface 1522 of the first movable portion 1210 and may include a second recessed structure 1554.

In some embodiments, the first intermediate element 1501 may be at least partially disposed between the first recessed structure 1553 and the second recessed structure 1554. The first intermediate element 1501 may be affixed in the first recessed structure 1553 movably disposed in the second recessed structure 1554. In some embodiments, the first recessed structure 1553 and the second recessed structure 1554 are different. For example, as shown in FIG. 3B, when viewed along the Z axis, the first recessed structure 1553 may have circular shape, and may have a first corresponding surface 1531 and a second corresponding surface 1532, as shown in FIG. 4B. The first corresponding surface 1531 and the second corresponding surface 1532 may correspond to the first intermediate element 1501, such as may be in direct contact with the first intermediate element 1501, or may have lubricating oil or glue between them and the first intermediate element 1501. The first corresponding surface 1531 is not parallel to the second corresponding surface 1532. Moreover, the bottom 1120 may further include a positioning portion 1533 extending from the first surface 1521 along the Z axis. The positioning portion 1533 surrounds a portion of the first intermediate element 1501 to define the position of the first intermediate element 1501.

In some embodiments, when viewed along a direction perpendicular to the second surface 1522 (such as viewed along the Z axis), the second recessed structure 1554 may be strip-shaped and may extend along a first virtual line 1904, such as extend along the Y axis. When viewed along a first rotational axis 1903, a connection 1905 connecting a center 1910 and the first rotational axis 1903 is not perpendicular to the first virtual line 1904. Moreover, in some embodiments, the first strengthen element 1541 and the second strengthen element 1542 may be disposed on the second recessed structure 1554, and may include a fourth corresponding surface 1534 and a fifth corresponding surface 1535, respectively. The fourth corresponding surface 1534 and the fifth corresponding surface 1535 may correspond to the first intermediate element 1501, such as may be in direct contact with the first intermediate element 1501, or may have lubricating oil or glue between them and the first intermediate element 1501. The fourth corresponding surface 1534 and the fifth corresponding surface 1535 are not parallel. Moreover, the fourth corresponding surface 1534 and the fifth corresponding surface 1535 are not parallel and not perpendicular to the first corresponding surface 1531 and the second corresponding surface 1532.

In some embodiments, the hardness (such as Vickers hardness) of the first main body 1511 is different from the hardness of the first strengthen element 1541 and the second strengthen element 1542, such as the hardness (such as Vickers hardness) of the first main body 1511 is less than the hardness of the first strengthen element 1541 and the second strengthen element 1542. In some embodiments, the material of the first main body 1511 may include ceramic or polymers such as plastic or resin, and the material of the first strengthen element 1541 and the second strengthen element 1542 may include metal to increase the structural strength of the position in contact with the first intermediate element 1501, so the durability of the optical element driving mechanism 1000 may be enhanced.

In some embodiments, the support assembly 1500 may further include a second intermediate element 1502 and a third intermediate element 1503 disposed between the first movable portion 1210 and the bottom 1120. When viewed along the optical axis 1900, the second intermediate element 1502 and the third intermediate element 1503 may be at least partially overlapping the first movable portion 1210 and the bottom 1120. As shown in FIG. 2C, the first movable portion 1210 may further include a second accommodating space 1122 and a third accommodating space 1123, the second intermediate element 1502 is at least partially disposed in the second accommodating space 1122, and the third intermediate element 1503 is at least partially disposed in the third accommodating space 1123.

In some embodiments, as shown in FIG. 3B, the second intermediate element 1502 may have a spherical shape and may include a size 1921 (such as diameter). The second accommodating space 1122 may have a size 1922 in a direction that the X axis extends, may have a size 1923 in a direction that the Y axis extends, and the size 1922 and the size 1923 are greater than the size 1921. In other words, when viewed along the optical axis 1900, the size 1922 or the size 1923 of the second accommodating space 1122 may be greater than the size 1921 of the second intermediate element 1502 to allow the second axis 1902 move freely in the second accommodating space 1122 without its position being constrained by the second accommodating space 1122. Similarly, when viewed along the optical axis 1900, the size of the third accommodating space 1123 may be greater than the size of the third intermediate element 1503 to allow the third intermediate element 1503 move freely in the third accommodating space 1123.

In some embodiments, as shown in FIG. 2C, a third strengthen element 1543 and a fourth strengthen element 1544 may be disposed on the second main body 1121 of the bottom 1120 and correspond to the second intermediate element 1502 and the third intermediate element 1503, respectively, such as they may in direct contact with the second intermediate element 1502 and the third intermediate element 1503, or may have lubricating oil or glue between them and the second intermediate element 1502 and the third intermediate element 1503. The third strengthen element 1543 and the fourth strengthen element 1544 may be partially embedded in the second main body 1121 and partially exposed from the second main body 1121. The hardness (such as Vickers hardness) may be less than the hardness of the third strengthen element 1543 and the hardness of the fourth strengthen element 1544 to enhance the mechanical strength at the position of the bottom 1120 in contact with the second intermediate element 1502 and the third intermediate element 1503 to increase the durability of the optical element driving mechanism 1000.

The second intermediate element 1502 and the third intermediate element 1503 may move freely in the second accommodating space 1122 and the third accommodating space 1123, respectively, and may move freely relative to the third strengthen element 1543 and the fourth strengthen element 1544, so the second intermediate element 1502 and the third intermediate element 1503 do not limit the movement direction of the first movable portion 1210 in the XY plane. In other words, the first movable portion 1210 may rotate relative to the fixed portion 1100 taking the first rotational axis 1903 as the rotational axis by this design, and the first movable portion 1210 may move in the Y axis along the first virtual line 1904. When the first movable portion 1210 rotates in a small angle (such as less than ±1 degree), the movement of the optical element disposed in the first movable portion 1210 may be similar to translational movement along the X axis. Therefore, such design can control the position of the optical element in the X axis or Y axis to achieve optical image stabilization.

In some embodiments, when viewed along the first rotational axis 1903, the first rotational axis 1903 does not overlap the center 1910 of the optical element. The center 1910 of the optical element such as may be defined as the center of circle of the opening 1221 when the second movable portion 1220 has the circular opening 1221 when viewed along the optical axis 1900 (viewed along the Z axis). The first rotational axis 1903 does not overlap the center 1910 of the optical element means the first rotational axis 1903 does not pass through the center 1910 of the optical element. In some embodiments, the first rotational axis 1903 is parallel to the optical axis 1900, such as parallel to the Z axis. In some embodiments, the first rotational axis 1903 does not pass through the optical element, such as does not pass through the opening 1221 of the second movable portion 1220 used for disposing the optical element.

In some embodiments, the support assembly 1500 may further include a force applying element 1560 which may be disposed in the bottom 1120 and spaced apart from the first intermediate element 1501. The force applying element 1560 may at least partially overlap the first strengthen element 1541 and the second strengthen element 1542 in the Z axis. In some embodiments, the force applying element 1560 may include magnet, and the first strengthen element 1541 and the second strengthen element 1542 may include magnetic permeable magnet to generate magnetic attraction force to the force applying element 1560 to generate a stabilizing force that keeps the first movable portion 1210 and the fixed portion 1100 in close contact with the first intermediate element 1501, thereby preventing the first intermediate element 1501 from falling out of the first recessed structure 1553 and the second recessed structure 1554. The force applying element 1560 may have a force applying element surface 1561 facing the first intermediate element 1501, the first strengthen element 1541, and the second strengthen element 1542, such as may have a normal vector parallel to the Z axis. The force applying element surface 1561, the fourth corresponding surface 1534, and the fifth corresponding surface 1535 is not perpendicular and is not parallel each other.

Although the first recessed structure 1553 has a circular recess in the previous embodiments, the present disclosure is not limited thereto. For example, FIG. 4C is an enlarged view of the area 1930 of FIG. 4A in other embodiments, and FIG. 4D is a schematic view of the bottom 1120 and the first intermediate element 1501. As shown in FIG. 4C and FIG. 4D, the first support element 1551a in these embodiments have a first recessed structure 1553a, and the first recessed structure 1553a may be a recess have tetrahedron shape and includes a first corresponding surface 1531a, a second corresponding surface 1532a, and a third corresponding surface 1533a. The first intermediate element 1501 may correspond to the first corresponding surface 1531a, the second corresponding surface 1532a, and the third corresponding surface 1533a, such as the first corresponding surface 1531a, the second corresponding surface 1532a, and the third corresponding surface 1533a may be in direct contact with the first intermediate element 1501 or may have lubricating oil or glue between them and the first intermediate element 1501. The first corresponding surface 1531a, the second corresponding surface 1532a, and the third corresponding surface 1533a do not parallel or perpendicular each other, and they do not parallel or perpendicular to the fourth corresponding surface 1534 and the fifth corresponding surface 1535.

In other words, the number of surfaces of the first recessed structure 1553a that correspond to the first intermediate element 1501 may be different from the number of surfaces of the second recessed structure 1554 that correspond to the first intermediate element 1501, such as the number of surfaces of the first recessed structure 1553a that correspond to the first intermediate element 1501 (3 surfaces) may be more than the number of surfaces of the second recessed structure 1554 that correspond to the first intermediate element 1501 (2 surfaces). Providing 3 surfaces at the first recessed structure 1553a that correspond to the first intermediate element 1501 (the first corresponding surface 1531a, the second corresponding surface 1532a, and the third corresponding surface 1533a), the position of the first intermediate element 1501 may be defined by three contact points to reduce the influence of the production tolerance.

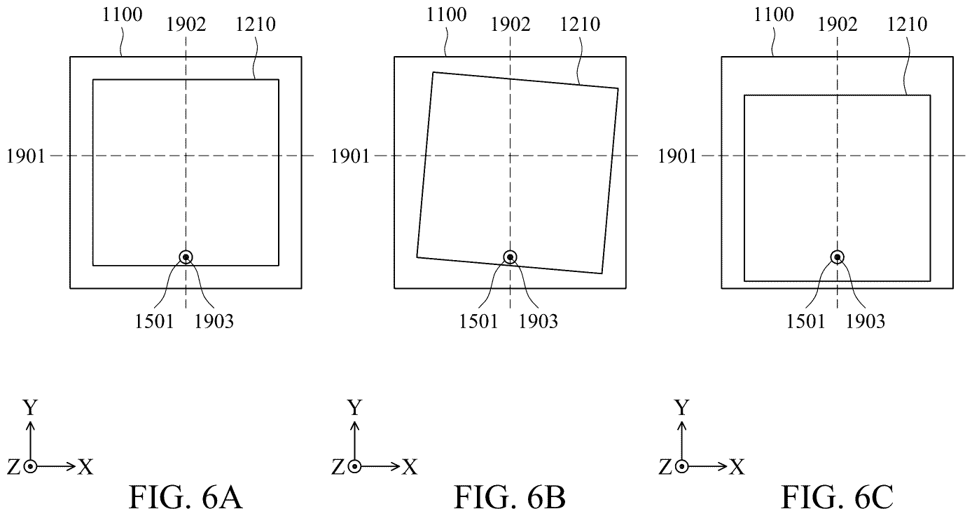

In some embodiments, as shown in FIG. 2A and FIG. 3B, the optical element driving mechanism 1000 may further include a sensing assembly 1720 used for detecting the movement of the first movable portion 1210. The sensing assembly 1720 may include a first sensing element 1721 and a second sensing element 1722 used to respectively detect the movement of the first movable portion 1210 along the first axis 1901 (such as the X axis) and the second axis 1902 (such as the Y axis) in FIG. 6A to FIG. 6C. In some embodiments, the first sensing element 1721 and the second sensing element 1722 may include a Hall sensor, a magnetoresistance effect sensor (MR sensor), a giant magnetoresistance effect sensor (GMR sensor), a tunneling magnetoresistance effect sensor (TMR sensor), or a fluxgate sensor.

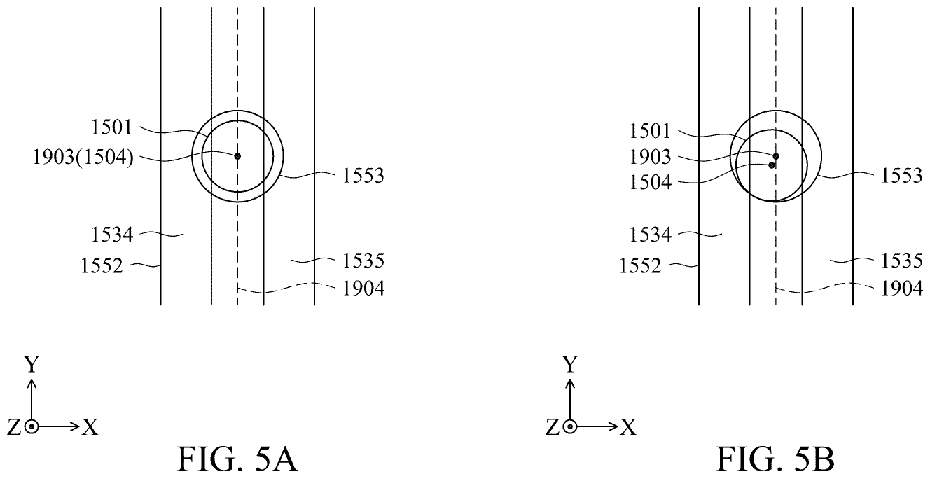

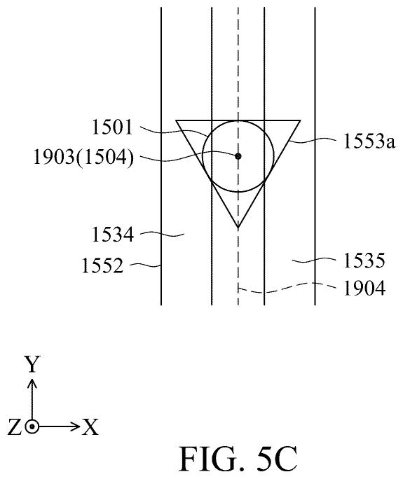

FIG. 5A and FIG. 5B are schematic views showing the positional relationships of some elements when the first movable portion 1210 is in the first state and the second state relative to the fixed portion 1100, respectively, when a first recessed structure 1553 having a cylindrical shape is used. As shown in FIG. 5A and FIG. 5B, when viewed along a direction perpendicular to the first surface 1521 (such as the Z direction), the center 1504 of the first intermediate element 1501 overlaps the first rotational axis 1903 in FIG. 5A (first state), and the center 1504 of the center 1504 does not overlap the first rotational axis 1903 in FIG. 5B (second state).

That is to say, distances between the center 1504 of the first intermediate element 1501 and the center of the first recessed structure 1553 (such as the intersection point of the first rotational axis 1903 and the first virtual line 1904) are different when in the first state and when in the second state. In other words, when the first movable portion 1210 moves relative to the fixed portion 1100, the first intermediate element 1501 may be displaced or rotated in the first recessed structure 1553.

FIG. 5C is a schematic view showing the positional relationships of some elements when the first movable portion 1210 is in the first state and the second state relative to the fixed portion 1100, respectively, when a first recessed structure 1553a having a triangular shape is used. It should be noted that distances between the center 1504 of the first intermediate element 1501 and the center of the first recessed structure 1553 when viewed along a direction perpendicular to the first surface 1521 are identical when in the first state and when in the second state, which means when the first movable portion 1210 moves relative to the fixed portion 1100 (such as moves along the X axis or the Y axis). For example, the center 1504 of the first intermediate element 1501 may overlap the center of the first recessed structure 1553a in the first state and the second state, or they may have fixed relative positions. In other words, when the first movable portion 1210 moves relative to the fixed portion 1100, the first intermediate element 1501 does not displace in the first recessed structure 1553a, but will only rotate.

FIG. 6A, FIG. 6B, and FIG. 6C are top views of some elements of the optical element driving mechanism 1000, which mainly show the first movable portion 1210 moves relative to the fixed portion 1100. In FIG. 6A, the first movable portion 1210 is at an initial position relative to the fixed portion 1100. In FIG. 6B, the first movable portion 1210 rotates in a clockwise direction taking the first rotational axis 1903 as the rotational axis. When the rotation angle is small (such as less than ±1 degree), the displacement of the optical element disposed in the first movable portion 1210 may be approximated as movement along the X axis. In FIG. 6C, the first movable portion 1210 moves along the Y axis. When viewed along the first rotational axis 1903, as shown in FIG. 3B, the first axis 1901 is not perpendicular to the connection 1905 connecting the center 1910 of the optical element and the first rotational axis 1903.

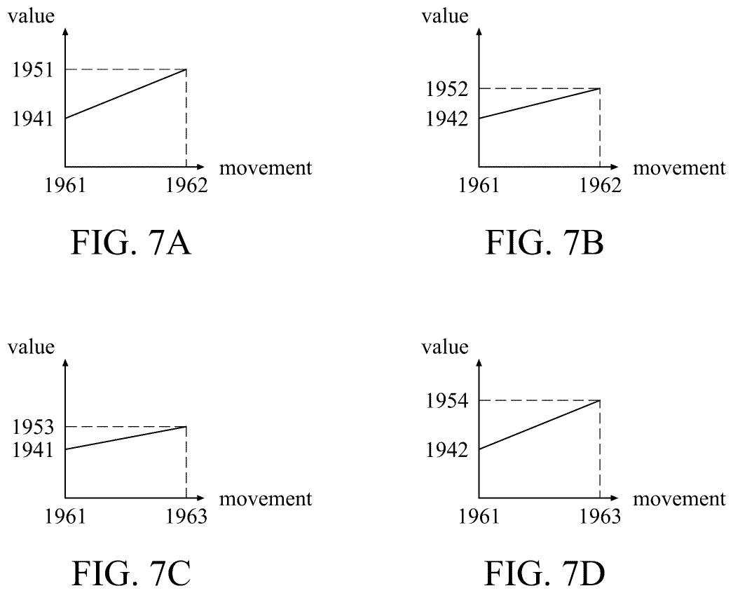

FIG. 7A, FIG. 7B, FIG. 7C, and FIG. 7D are schematic views showing sensor signal values output when the first movable portion 1210 moves relative to the fixed portion 1100. FIG. 7A illustrates the output values of the first sensing element 1721 as the first movable portion 1210 moves from an initial position 1961 to a first position 1962 along the first axis 1901. FIG. 7B shows the output values of the second sensing element 1722 as the first movable portion 1210 moves from the initial position 1961 to the first position 1962 along the first axis 1901. FIG. 7C illustrates the output values of the first sensing element 1721 as the first movable portion 1210 moves from the initial position 1961 to a second position 1963 along the second axis 1902. FIG. 7D shows the output values of the second sensing element 1722 as the first movable portion 1210 moves from the initial position 1961 to the second position 1963 along the second axis 1902.

As shown in FIG. 7A and FIG. 7B, when the first movable portion 1210 is at the initial position 1961, the first sensing element 1721 outputs a first initial value 1941, and the second sensing element 1722 outputs a second initial value 1942. Then, as the first movable portion 1210 moves from the initial position 1961 to the first position 1962 along the first axis 1901, the first sensing element 1721 outputs a first sensed value 1951, and the second sensing element 1722 outputs a second sensed value 1952. Additionally, as shown in FIG. 7C and FIG. 7D, when the first movable portion 1210 moves from the initial position 1961 to the second position 1963 along the second axis 1902, the first sensing element 1721 outputs a third sensed value 1953, and the second sensing element 1722 outputs a fourth sensed value 1954.

It should be noted that the degree of movement of the first position 1962 relative to the initial position 1961 is the same as the degree of movement of the second position 1963 relative to the initial position 1961. For example, if the first position 1962 has moved 50% of the maximum stroke (first limit range) along the first axis 1901 relative to the initial position 1961, then the second position 1963 has also moved 50% of the maximum stroke (second limit range) along the second axis 1902 relative to the initial position 1961. The initial position 1961 can be located at the center of the first limit range and the second limit range. In some embodiments, the difference of the absolute value between the first position 1962 and the initial position 1961 is at least greater than one-fourth of the first limit range.

However, the absolute distances of the first movable portion 1210 moved along the first axis 1901 and the second axis 1902 are not the same. Therefore, at corresponding stroke along the first axis 1901 and the second axis 1902, the values output by the first sensing element 1721 and the second sensing element 1722 may not necessarily be the same. For example, the difference of absolute value between the second sensed value 1952 and the second initial value 1942 may differ from the difference of absolute value between the third sensed value 1953 and the first initial value 1941. Specifically, the difference of absolute value between the second sensed value 1952 and the second initial value 1942 may be greater than the difference of absolute value between the third sensed value 1953 and the first initial value 1941. Additionally, the difference of absolute value between the first sensed value 1951 and the second sensed value 1952 may differ from the difference of absolute value between the third sensed value 1953 and the fourth sensed value 1954. For example, the difference of absolute value between the first sensed value 1951 and the second sensed value 1952 may be smaller than the difference of absolute value between the third sensed value 1953 and the fourth sensed value 1954.

In summary, an optical element driving mechanism is provided, which includes a first movable portion, a fixed portion, and a driving assembly. The first movable portion is used for connecting an optical element. The first movable portion is movable relative to the fixed portion. The driving assembly is used for driving the first movable portion to move relative to the fixed portion. The driving assembly can drive the first movable portion to move from a first state to a second state relative to the fixed portion, and the first state and the second state are included in a movable range. Therefore, auto focus may be performed, the position of the movable portion may be stabilized, and miniaturization may be achieved.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. An optical element driving mechanism, comprising:
a first movable portion used for connecting an optical element;
a fixed portion, wherein the first movable portion is movable relative to the fixed portion; and
a driving assembly used for driving the first movable portion to move relative to the fixed portion;
wherein the driving assembly can drive the first movable portion to move from a first state to a second state relative to the fixed portion, and the first state and the second state are included in a movable range.

2. The optical element driving mechanism as claimed in claim 1, further comprising a support assembly, wherein the first movable portion is movable relative to the fixed portion through the support assembly, and the support assembly comprises:
a first intermediate element;
a first support element corresponding to the first intermediate element and having a first recessed structure, wherein the first recessed structure is formed on a first surface; and
a second support element corresponding to the first intermediate element and having a second recessed structure, wherein the second recessed structure is formed on a second surface.

3. The optical element driving mechanism as claimed in claim 2, wherein:
the first intermediate element is at least partially disposed in the first recessed structure and the second recessed structure;
the first recessed structure is different from the second recessed structure;
the first movable portion is rotatable relative to the fixed portion around a first rotational axis, and the first rotational axis does not overlap a center of the optical element when viewed along the first rotational axis.

4. The optical element driving mechanism as claimed in claim 3, wherein:
the first rotational axis does not pass through the optical element when viewed along the first rotational axis;
the optical element includes an optical axis parallel to the first rotational axis;
the second recessed structure is strip-shaped and extends along a first virtual line when viewed along a direction perpendicular to the second surface;
a connection between the center of the optical element and the first rotational axis is not perpendicular to the first virtual line when viewed along the first rotational axis.

5. The optical element driving mechanism as claimed in claim 4, wherein:
the first recessed structure comprises:
a first corresponding surface corresponding to the first intermediate element;
a second corresponding surface corresponding to the first intermediate element; and
a third corresponding surface corresponding to the first intermediate element;
the second recessed structure comprises:
a fourth corresponding surface corresponding to the first intermediate element; and
a fifth corresponding surface corresponding to the first intermediate element.

6. The optical element driving mechanism as claimed in claim 5, wherein:
the second corresponding surface is not perpendicular to the first corresponding surface;
the third corresponding surface is not parallel to the first corresponding surface;
the third corresponding surface is not parallel to the second corresponding surface;
the fourth corresponding surface is not parallel and not perpendicular to the first corresponding surface, the second corresponding surface, and the third corresponding surface;
number of surfaces of the first recessed structure that correspond to the first intermediate element is more than number of surfaces of the second recessed structure that correspond to the first intermediate element;
distances between a center of the first intermediate element and a center of the first recessed structure when viewed along a direction perpendicular to the first surface are identical when in the first state and when in the second state.

7. The optical element driving mechanism as claimed in claim 4, wherein:
the first recessed structure comprises:
a first corresponding surface corresponding to the first intermediate element; and
a second corresponding surface corresponding to the first intermediate element;
the second recessed structure comprises:
a fourth corresponding surface corresponding to the first intermediate element; and
a fifth corresponding surface corresponding to the first intermediate element;
the second corresponding surface is not parallel to the first corresponding surface;
the fifth corresponding surface is not parallel to the fourth corresponding surface.

8. The optical element driving mechanism as claimed in claim 7, wherein:
the fourth corresponding surface is not parallel to the first corresponding surface and the second corresponding surface;
the fourth corresponding surface is not perpendicular to the first corresponding surface and the second corresponding surface;
the fifth corresponding surface is not parallel to the first corresponding surface and the second corresponding surface;
the fifth corresponding surface is not perpendicular to the first corresponding surface and the second corresponding surface;
distances between a center of the first intermediate element and a center of the first recessed structure when viewed along a direction perpendicular to the second surface are different when the first movable portion is in the first state and in the second state.

9. The optical element driving mechanism as claimed in claim 8, wherein:
the support assembly further comprises:
a first main body, wherein the second surface is formed on the first main body;
a first strengthen element disposed on the second recessed structure, and the fourth corresponding surface is formed on the first strengthen element;
a positioning portion extending from the first surface; and
a force applying element used for generating a stabilizing force that keeps the first movable portion and the fixed portion in close contact with the first intermediate element.

10. The optical element driving mechanism as claimed in claim 9, wherein:
a hardness of the first main body is less than a hardness of the first strengthen element;
the positioning portion surrounds a portion of the first intermediate element;
the force applying element comprises magnets, and the first strengthen element comprises a magnetically permeable material;
the force applying element comprises a force applying element surface facing the first intermediate element;
the force applying element surface is not parallel and not perpendicular to the fourth corresponding surface;
the force applying element surface is not parallel and not perpendicular to the fifth corresponding surface;
the force applying element surface faces the first strengthen element.

11. The optical element driving mechanism as claimed in claim 4, further comprising a sensing assembly used for sensing movement of the first movable portion, wherein the sensing assembly comprises:
a first sensing element used for detecting a movement of the first movable portion along a first axis; and
a second sensing element used for detecting a movement of the first movable portion along a second axis.

12. The optical element driving mechanism as claimed in claim 11, wherein:
the first axis is not perpendicular to a connection between the center of the optical element and the first rotational axis when viewed along the first rotational axis;
when the first movable portion is at an initial position, the first sensing element outputs a first initial value, and the second sensing element outputs a second initial value;
when the first movable portion moves from the initial position to a first position along the first axis, the first sensing element outputs a first sensed value, and the second sensing element outputs a second sensed value;
when the first movable portion moves from the initial position to a second position along the second axis, the first sensing element outputs a third sensed value, and the second sensing element outputs a fourth sensed value.

13. The optical element driving mechanism as claimed in claim 12, wherein:
degree of movement of the first position relative to the initial position is the same as degree of movement of the second position relative to the initial position;
difference of absolute value between the second sensed value and the second initial value is different from difference of an absolute value between the third sensed value and the first initial value.

14. The optical element driving mechanism as claimed in claim 13, wherein:
the difference of absolute value between the second sensed value and the second initial value is greater than the difference of absolute value between the third sensed value and the first initial value;
the first movable portion is movable along the first axis in a first limit range;
the initial position is at a center of the first limit range;
the difference of absolute value between the first position and the initial position is at least greater than one-fourth of the first limit range;
difference of absolute value between the first sensed value and the second sensed value is different from difference of the absolute value between the third sensed value and the fourth sensed value.

15. The optical element driving mechanism as claimed in claim 3, wherein:
the fixed portion comprises a bottom;
the bottom comprises a second main body;
the support assembly further comprises:
a second intermediate element disposed between the fixed portion and the first movable portion;
a third intermediate element disposed between the fixed portion and the first movable portion;
a third strengthen element disposed on the bottom; and
a fourth strengthen element disposed on the bottom.

16. The optical element driving mechanism as claimed in claim 15, wherein:
the optical element comprises an optical axis;
the second intermediate element and the third intermediate element at least partially overlap the first movable portion and the bottom;
the first movable portion comprises a second accommodating space and a third accommodating space;
the second intermediate element is at least partially disposed in the second accommodating space;
the third intermediate element is at least partially disposed in the third accommodating space.

17. The optical element driving mechanism as claimed in claim 16, wherein:
a size of the second accommodating space is greater than a size of the second intermediate element when viewed along the optical axis;
a size of the third accommodating space is greater than a size of the third intermediate element when viewed along the optical axis.

18. The optical element driving mechanism as claimed in claim 17, wherein:
the third strengthen element corresponds to the second intermediate element;
the fourth strengthen element corresponds to the third intermediate element;
the third strengthen element is partially embedded in the second main body;
the third strengthen element is partially exposed from the second main body;
the fourth strengthen element is partially embedded in the second main body;
the fourth strengthen element is partially exposed from the second main body;
hardness of the second main body is less than hardness of the third strengthen element and hardness of the fourth strengthen element.

19. The optical element driving mechanism as claimed in claim 1, further comprising an intermediate assembly and a second movable portion;
wherein:
the second movable portion is movably connected to the fixed portion;
the second movable portion is movably connected to the first movable portion;
the second movable portion is disposed in the first movable portion;
the intermediate assembly comprises:
a first intermediate unit affixed on one of the first movable portion and the second movable portion;
a second intermediate unit affixed on one of the first movable portion and the second movable portion;
a first auxiliary magnetic element corresponding to the first intermediate unit; and
a second auxiliary magnetic element corresponding to the second intermediate unit.

20. The optical element driving mechanism as claimed in claim 19, wherein:
the second movable portion is partially disposed between the first intermediate unit and the first auxiliary magnetic element;
the second movable portion is partially disposed between the second intermediate unit and the second auxiliary magnetic element;
the first intermediate unit comprises a magnetically permeable material;
the second intermediate unit comprises a magnetically permeable material.
